(19) United States
(12) Patent Application Publication
(10) Pub. No.: US 2013/0022777 A1
(43) Pub. Date: Jan. 24, 2013

(54) DECORATIVE LABEL

(71) Applicant: Dennis Smolinski, Warren, MI (US)

(72) Inventor: Dennis Smolinski, Warren, MI (US)

(21) Appl. No.: 13/552,133

(22) Filed: Jul. 18, 2012

Related U.S. Application Data
(60) Provisional application No. 61/508,956, filed on Jul. 18, 2011.

(51) Int. Cl. B32B 3/02; B32B 33/00

(52) U.S. Cl. 428/99

(57) ABSTRACT

A decorative label for a fluid container includes a translucent sheet of polymeric material having a pair of side edges, a back surface that is intended to overlie an exterior surface of the container, and a front surface. The front surface of the sheet has a decorative aspect disposed on at least a portion thereof to enhance aesthetics of the fluid container. The decorative aspect includes a window portion integrated therein that permits the exterior surface of the fluid container to be visible through the sheet of polymeric material. A plurality of retention mechanism are disposed on the back surface of the translucent sheet to maintain the label in position on the fluid container.

### CROSS-REFERENCE TO RELATED APPLICATIONS

The present application claims priority to U.S. Provisional Patent Application Ser. No. 61/508,956, filed Jul. 18, 2011 and entitled “Decorative Label”, which application is hereby incorporated by reference, as though set forth fully herein.

### TECHNICAL FIELD

The present invention relates broadly to a decorative label for a container. More specifically, the present invention relates to a decorative label for a fluid container that is readily releasable to allow for different decorative labels to be placed around the container at different times.

### BACKGROUND ART

Containers that house fluids, such as those utilized to house disinfectants, are well known. For example, containers that house disinfectants are known to be used in beauty salons and barber shops to assist in cleaning scissors, combs and the like between uses. These containers have sides that are typically made of glass or other transparent material as pertinent regulations in the beauty industry require that the amount of fluid in the container be visible through the container. These containers can thus be unsightly and unattractive.

Efforts to make these containers more aesthetically pleasing have involved adhering a decorative sticker or other graphic layer directly onto the container exterior. However, because of the requirement that the fluid in the container be seen from the exterior, these stickers generally do not cover the entirety of the container exterior surface and leave a gap between the sides or ends of the sticker so that the fluid within the container can be seen. Because the decorative sticker or other graphic layer has been applied directly to the exterior of the container, they cannot be readily removed. To the extent that they can be removed, the stickers are generally destroyed and, in any event, cannot be reused at a later time.

### SUMMARY OF THE INVENTION

It is therefore an advantage of the present invention to provide a decorative label for a fluid container that is readily releasable.

It is a related advantage of the present invention to provide a decorative label for a container housing a disinfectant fluid, which is readily releasable.

It is another advantage of the present invention to provide a decorative label for a fluid container that provides improved aesthetics and is interchangeable.

It is a related advantage of the present invention to provide a decorative label for a container housing a disinfectant fluid, which provides improved aesthetics and is interchangeable.

It is still another advantage of the present invention to provide a decorative label for a fluid container that provides improved aesthetics while allowing the amount of fluid in the container to remain visible from the exterior of the container.

It is a related advantage of the present invention to provide a decorative label for a container housing a disinfectant fluid, which provides improved aesthetics while allowing the amount of fluid in the container to remain visible from the exterior of the container.

In accordance with the above and the other advantages of the present invention, a decorative label for a fluid container is provided. The label consists of a sheet of material having a front surface that faces outwardly and a back surface that is intended to overlie an exterior surface of the container. The sheet of material also includes a pair of sides. The front surface of the sheet includes a decorative layer disposed thereon. At least one retention mechanism is disposed adjacent each of the pair of sides that couple to one another to retain the decorative label in place around the container. The decorative label is configured such that when it is retained in place around the exterior surface of the container at least of portion of the exterior surface is visible so that the level of fluid in the container can be seen.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front view of an exemplary decorative label in accordance with an aspect of the present disclosure;

FIG. 2 is a perspective view of the decorative label of FIG. 1 oriented to fit around a container;

FIG. 3 is a side view of a decorative label secured to a container in accordance with an aspect of the present disclosure;

FIG. 4 is a side view of a decorative label secured to a container in accordance with another aspect of the present invention.

FIG. 5 is a front view of an exemplary decorative label in accordance with another aspect of the present disclosure; and

FIG. 6 is a perspective view of the decorative label of FIG. 4 oriented to fit around a container.

### DETAILED DESCRIPTION OF THE ENABLING EMBODIMENTS

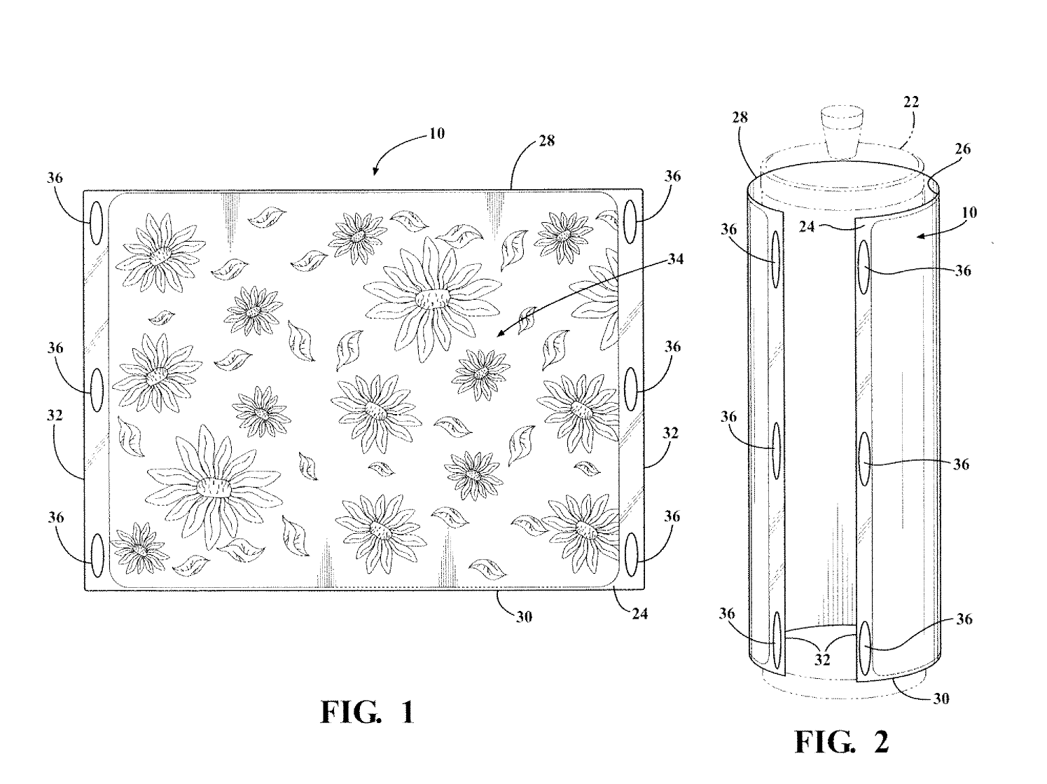

Referring to the figures, where like numerals indicate corresponding parts throughout the several views, a decorative label 10 for a container 22 is generally shown in FIG. 1. In the exemplary embodiment of FIG. 1, the decorative label 10 consists of a sheet of material that is generally flat and has a front surface 24, a back surface 26, a top edge 28, a bottom edge 30 and opposing side edges 32. As will be discussed in greater detail below, the front surface 24 of the decorative label 10 may include a decorative layer 34 for altering the appearance of the container 22. The decorative layer 34 can be a graphic image, a color, lettering, or any combination thereof, as discussed in more detail below. According to one aspect, the container 22 is a fluid container that can be used to hold a disinfectant fluid, such as is employed in barber shops, salons, and the like. The container 22 may come in different sizes and shapes.

In accordance with an aspect, the decorative label 10 can be easily removed from engagement with or easily secured around the container 22. The appearance of the container 22 can be quickly and easily altered by removing one decorative label 10 from the container 22 and substituting another decorative label 10 with a different image, which is secured around the container 22. According to an aspect, the decorative label 10 is made of a flexible material so that it can easily be bent, such as into a curve, as exemplarily shown in FIG. 2 or other shape in order to correspond to the shape of the exterior surface of the container 22.

In accordance with an aspect of the disclosure, the decorative label 10 has dimensions, which generally match corresponding dimensions of the container 22 to be decorated. In other words, the decorative label 10 is dimensioned for a particular size of container 22. For example, where the container 22 is configured as a cylinder, the height of the decorative label 10 generally corresponds to the height of the container 22 and the length of the decorative label 10 generally corresponds to the circumference of the container 22. It will be understood that the dimensions of the decorative label 10 can vary. As an example, the height of the decorative label 10 can be less than the height of the container 22 so that portions of the container 22 will be visible above and/or below the decorative label 10. Similarly, the length of the decorative label 10 can be smaller than the circumference of the container 22. In addition to being sized to fit around containers of different sizes, the decorative label 10 can be sized to be secured around containers of different shapes, such as rectangular, square, oval, or the like.

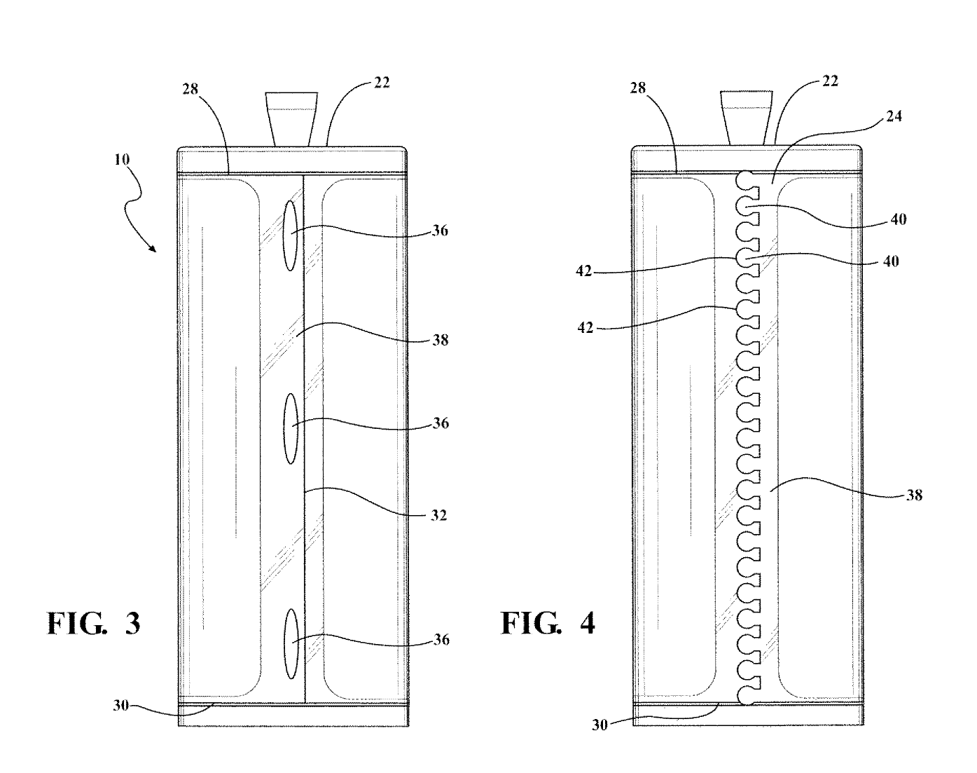

As shown in FIGS. 1-3, the decorative label 10 can include a plurality of magnets 36 disposed along each of the side edges 32. The magnets 36 on one of the edges 32 are intended to align with the magnets on the opposing edge 32 in order to secure the label 10 in place around the container 22 as shown in FIG. 3. It will be understood that more or less magnets may be utilized. It will also be understood that magnets may also or alternatively be located along the bottom edge 30 and top edge 32 of the decorative label 10 to retain it around the exterior surface of the container 22. It will be understood that a variety of different retention mechanisms can be employed to secure the decorative label 10 around the container 22.

The decorative label 10 is preferably made of a generally translucent polymeric material. However, it could be constructed of a variety of other suitable types of materials. In the exemplary embodiment, the decorative layer 34 is placed over at least a portion of the front surface 24 of the decorative label 10 to give it a desired appearance. The decorative layer 34 can take the form of a sticker and, as discussed above, can include one or a combination of a graphic image, wording, color, or any other suitable content to provide enhanced aesthetics, such as a photograph, painting, emblem, or pattern. It will also be appreciated that the decorative layer 34 could also be printed directly on the label or attached to the decorative label 10 in any desirable way. The decorative layer 34 can also be an integral part of the sheet 20.

Where graphics of the like are printed on the decorative layer 34, it may be preferred for the front surface 24 of the decorative label 10 to be generally flat for receiving the sticker 40. However, it should be appreciated that the label 10 could have other surface features including, for example, dimples (not shown), bumps (not shown) or ridges (not shown) to create a particular appearance.

In the exemplary embodiment of FIG. 3, the decorative label 20 includes a window portion 38 that is translucent or transparent and also free of any graphics that would block sight therethrough. If the container 22 is translucent or transparent, such as the container 22 of FIG. 3, this window portion 38 allows a person to see the fluid level inside of the container 22. This window portion 38 can extend the height of the label 10, although it should be appreciated that it could alternately extend along only a portion 38 of the height of the label 10. In accordance with one aspect, the window portion 38 can be aligned with the magnets 36 along the side edges 32 of the decorative label 10, as shown in FIG. 3. In accordance with another aspect, the window portion 38 could be located in other parts of the label 10 to provide an opening through which the contents of the container 22 can be seen.

In accordance with another aspect, the window portion 38 could consist of a gap between the opposing side edges 32. In this configuration, the length of the sheet would be designed less than the dimension of the outer perimeter of the container 22. The decorative layer 34 could then overlie the entire front surface 24 of the sheet 20.

The container 22 could be any type of container 22, such as a bottle, a jar, a glass, etc. For example, in the exemplary embodiments of FIGS. 3 and 4, the container 22 can be a disinfectant jar of the type for cleaning combs, scissors, or the like in a barber shop, hair cutting salon or similar establishment. The decorative label 10 is particularly effective in such a business because the business can quickly customize the look of the office by switching the decorative labels 10 of each of the containers 22 in the business.

The configuration of the decorative label 10 allows it to be easily placed on the container 22 and then removed so that another decorative label 10 can be substituted therefore. This may be desirable for handling purposes or to promote special events, such as having a decorative label 10 colored pink to promote breast cancer awareness. In other words, the decorative label 10 is interchangeable.

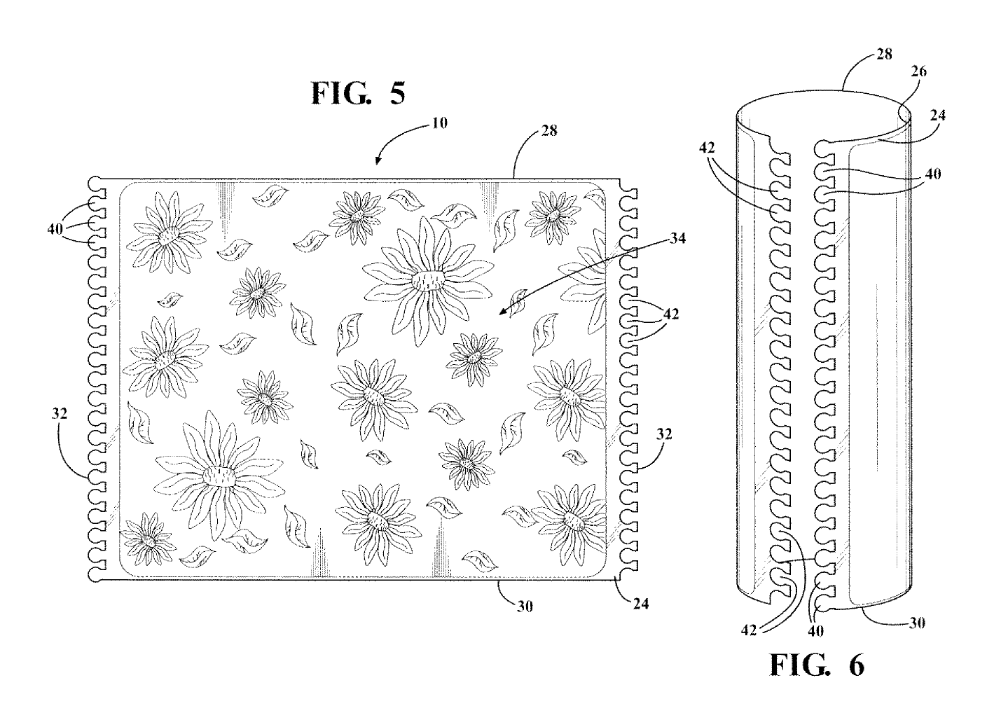

Referring now to FIGS. 4-6, which illustrate a decorative label 10 in accordance with another aspect of the disclosure. As shown, the principal difference between the decorative label 10 in these figures is the retention mechanism. FIGS. 4-6 illustrate a retention mechanism to secure the label 10 around the container 22 that consists of plurality of projections 40 and slots 42 disposed along opposing side edges 32 of the sheet 20. The slots 42 are positioned and sized to receive a corresponding projection 40. It should be appreciated that the decorative label 10 could include any desirable number of projections 40 and slots 42. Further, the projections 40 and corresponding slots 42 could take any desirable shape. Moreover, each of the opposing side edges 32 of the decorative label 10 could include both projections 40 and slots 42 so long as each projection 40 is aligned with a slot 42 on the opposing side edge 32 of the decorative label 10. Further, the projections 40 and corresponding slots 42 could take any desirable shape. As discussed above, a variety of other suitable retention mechanisms can also be employed.

As shown in FIG. 4, to engage the decorative label 10 with the container 22, a person can wrap the decorative label 10 around the perimeter of the container 22 and insert the projections 40 into the corresponding slots 42. As also shown in FIG. 4, the decorative label 10 has a height approximately similar to the height of the container 22 so that the sides of the container 22 are entirely covered by the decorative label 10. Again, it should be appreciated that the decorative label 10 could have any desirable height. For example, it might be desirable for the decorative label 10 to have a height which is less than the height of the container 22. The decorative label 10 also has a width which is thick enough to allow the projections 34 to sufficiently engage the slots 36.

Obviously, many modifications and variations of the present invention are possible in light of the above teachings and may be practiced otherwise than as specifically described herein.

What is claimed is:

1. A decorative label for a container configured to house a fluid, comprising:
a sheet of material having a pair of side edges, a back surface that is intended to overlie an exterior surface of the container, and a front surface;
a decorative layer disposed on at least a portion of said front surface;
at least one retention mechanism disposed adjacent each of said pair of side edges to retain the decorative label in place around the container; and
a window portion formed in said decorative layer, said window portion being translucent so that when it is retained in place around said exterior surface of the container at least of portion of said exterior surface is visible so that the fluid in the container can be seen.

2. The decorative label of claim 1, wherein said sheet of material is configured to fit around a generally cylindrical container.

3. The decorative label of claim 2, wherein said sheet of material is generally rectangular in shape.

4. The decorative label of claim 1, wherein said sheet of material is substantially transparent.

5. The decorative label of claim 1, wherein said decorative layer is selected from one or more of the following: a color, an image, lettering, or a photograph.

6. The decorative label of claim 1, wherein said at least one retention mechanism is a magnet.

7. The decorative label of claim 1, wherein said at least one retention mechanism is a fastener.

8. The decorative label of claim 1, further comprising:
a plurality of retention mechanism disposed adjacent each of said pair of opposing edges.

9. The decorative label of claim 1, wherein said sheet of material is formed of a polymeric material.

10. A decorative label for a fluid container, comprising:
a translucent sheet of polymeric material having a pair of side edges, a back surface that is intended to overlie an exterior surface of the container, and a front surface;
a decorative aspect being disposed on at least a portion of said front surface to enhance aesthetics of the fluid container;
a window portion being disposed in said decorative aspect that permits said exterior surface of the fluid container to be visible through said sheet of polymeric material; and
a plurality of retention mechanism disposed on said back surface of said translucent sheet to maintain the label in position on the fluid container.

11. The decorative label of claim 10, wherein at least one of said plurality of retention mechanism is disposed adjacent each of said pair of side edges.

12. The decorative label of claim 11, wherein said plurality of retention mechanism are magnets.

13. The decorative label of claim 12, wherein said decorative aspect consists of one or more of the following: a color, an image, lettering, or a photograph.

14. The decorative label of claim 13, wherein said sheet of material is configured to fit around a generally circular container.

15. The decorative label of claim 14, wherein said sheet of material is sized to substantially match dimensions of said exterior surface of said generally circular container.

16. The decorative label of claim 15, wherein said sheet of material is generally rectangular in shape.

17. The decorative label of claim 16, wherein said sheet of material is substantially transparent.

18. The decorative label of claim 11, wherein said plurality of retention mechanism are fasteners.

19. The decorative label of claim 11, wherein said window portion is located adjacent the side edges of said sheet.
